(19) United States
(12) Patent Application Publication
(10) Pub. No.: US 2006/0026179 A1
(43) Pub. Date: Feb. 2, 2006

(54) Workload group trend analysis in a database system

(76) Inventors: Douglas P. Brown, Rancho Santa Fe, CA (US); Bhashyam Ramesh, Secunderabad (IN); Anita Richards, San Juan Capistrano, CA (US)

Correspondence Address: John D. Cowart;Intellectual Property Section, NCR Corporation, 1700 South Patterson Blvd., Dayton, OH, 45479-0001, US

(21) Appl. No.: 11/027,896

(22) Filed: Dec. 30, 2004

Related U.S. Application Data
(63) Continuation-in-part of application No. 10/730,348, filed on Dec. 8, 2003.

(51) Int. Cl. G06F 7/00

(52) U.S. Cl. 707/100

(57) ABSTRACT

The described technique is for use in analyzing performance of a database system as it executes requests that are sorted into multiple workload groups, where each workload group has an associated level of service that is desired from the database system. The technique involves gathering data that describes performance metrics for the database system as it executes the requests in at least one of the workload groups, organizing the data in a format that shows changes in the performance metrics over time, and delivering the data in this format for viewing by a human user.

### CROSS REFERENCE TO RELATED APPLICATIONS

This application is a continuation-in-part of U.S. application Ser. No. 10/730,348, filed on Dec. 8, 2003, by Douglas P. Brown, Anita Richards, Bhashyam Ramesh, Caroline M. Ballinger, and Richard D. Glick, titled “Administering the Workload of a Database System Using Feedback,” and of U.S. application Ser. No. 11/027,896, filed on Dec. 30, 2004, by Douglas P. Brown, Bhashyam Ramesh, and Anita Richards, titled “Workload Group Trend Analysis in a Database System.”

### BACKGROUND

As database management systems continue to increase in function and to expand into new application areas, the diversity of database workloads, and the problem of administering those workloads, is increasing as well. In addition to the classic relational DBMS “problem workload,” consisting of short transactions running concurrently with long decision support queries and load utilities, workloads with an even wider range of resource demands and execution times are expected in the future. New complex data types (e.g., Large Objects, image, audio, video) and more complex query processing (rules, recursion, user defined types, etc.) will result in widely varying memory, processor, and disk demands on the system.

### SUMMARY

Described below is a technique for use in analyzing performance of a database system as it executes requests that are sorted into multiple workload groups, where each workload group has an associated level of service that is desired from the database system. The technique involves gathering data that describes performance metrics for the database system as it executes the requests in at least one of the workload groups, organizing the data in a format that shows changes in the performance metrics over time, and delivering the data in this format for viewing by a human user.

In certain embodiments, the data gathered indicates an average arrival rate for requests in at least one of the workload groups during each of multiple measured time periods. The data might also indicate an average response time by the database system or an amount of CPU time consumed in completing requests from the workload group during the measured time periods. The data might also indicate the number of requests in a workload group for which an actual level of service exceeds the desired level of service during the measured time periods. In some embodiments, the data identifies the workload groups by name.

In certain embodiments, the data is organized in tabular format, with each tabular row storing performance metrics gathered during one of the measured time periods; in others, the data is organized in graphical format, with one graphical axis representing the passage of the measured time periods. In some embodiments, the user is allowed to change the format in which the data is organized for display or to change the display from one set of performance metrics to another.

### BRIEF DESCRIPTION OF THE DRAWINGS

FIG. 1 is a block diagram of a node of a database system.

FIG. 2 is a block diagram of a parsing engine.

FIG. 3 is a block diagram of a parser.

FIGS. 4-8 are block diagrams of a system for administering the workload of a database system using feedback.

FIGS. 9-14 are screen shots illustrating the selection of service level agreement parameters.

FIG. 15 is a flow chart illustrating the flow of workload processing.

FIG. 16 is a block diagram of a system for monitoring the performance of workload groups in a database system.

FIG. 17 is a diagram illustrating a “dashboard” graphical-user interface (GUI) for use by a database administrator (DBA) in monitoring the performance of workload groups in a database system.

FIG. 18 is a block diagram of a system for conducting workload group trend analysis in a database system.

FIGS. 19, 20, 21, 22 and 23 are diagrams illustrating several components of a graphical user interface that aids a human user in conducting workload group trend analysis.

### DETAILED DESCRIPTION

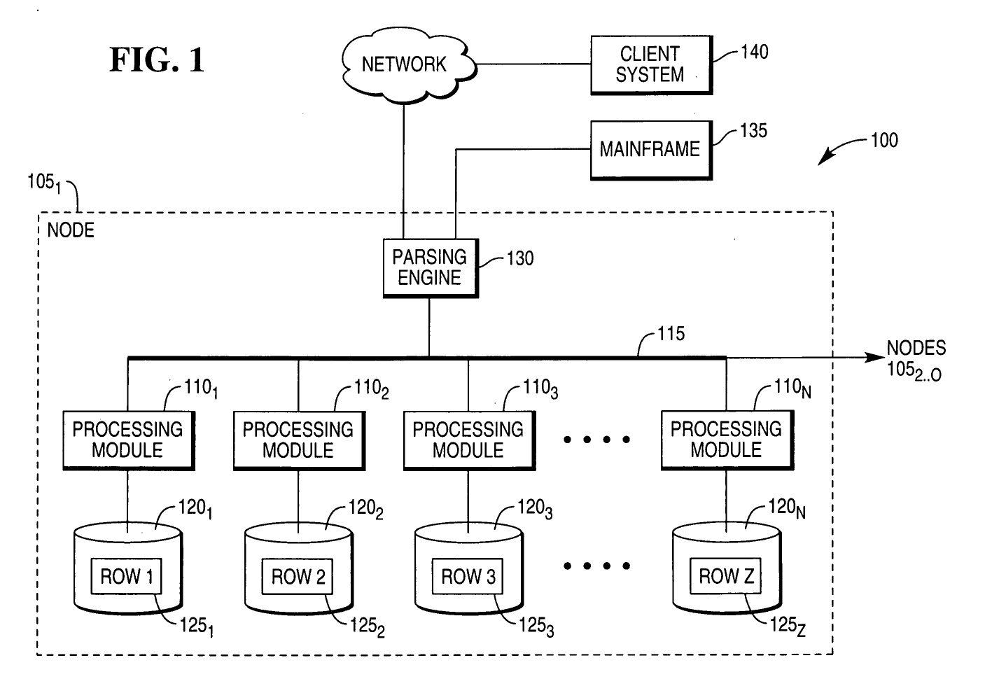

The technique for administering the workload of a database system using feedback disclosed herein has particular application, but is not limited, to large databases that might contain many millions or billions of records managed by a database system (“DBS”) 100, such as a Teradata Active Data Warehousing System available from NCR Corporation. FIG. 1 shows a sample architecture for one node 105₁ of the DBS 100. The DBS node 105₁ includes one or more processing modules 110_{1 . . . N}, connected by a network 115, that manage the storage and retrieval of data in data-storage facilities 120_{1 . . . N}. Each of the processing modules 110_{1 . . . N} may be one or more physical processors or each may be a virtual processor, with one or more virtual processors running on one or more physical processors.

For the case in which one or more virtual processors are running on a single physical processor, the single physical processor swaps between the set of N virtual processors.

For the case in which N virtual processors are running on an M-processor node, the node's operating system schedules the N virtual processors to run on its set of M physical processors. If there are 4 virtual processors and 4 physical processors, then typically each virtual processor would run on its own physical processor. If there are 8 virtual processors and 4 physical processors, the operating system would schedule the 8 virtual processors against the 4 physical processors, in which case swapping of the virtual processors would occur.

Each of the processing modules 110_{1 . . . N} manages a portion of a database that is stored in a corresponding one of the data-storage facilities 120_{1 . . . N}. Each of the data-storage facilities 120_{1 . . . N} includes one or more disk drives. The DBS may include multiple nodes 105_{2 . . . O} in addition to the illustrated node 105₁, connected by extending the network 115.

The system stores data in one or more tables in the data-storage facilities 120_{1 . . . N}. The rows 125_{1 . . . Z} of the tables are stored across multiple data-storage facilities 120_{1 . . . N} to ensure that the system workload is distributed evenly across the processing modules 110_{1 . . . N}. A parsing engine 130 organizes the storage of data and the distribution of table rows 125_{1 . . . Z} among the processing modules 110_{1 . . . N}. The parsing engine 130 also coordinates the retrieval of data from the data-storage facilities 120_{1 . . . N} in response to queries received from a user at a mainframe 135 or a client computer 140. The DBS 100 usually receives queries and commands to build tables in a standard format, such as SQL.

In one implementation, the rows 125_{1 . . . Z} are distributed across the data-storage facilities 120_{1 . . . N} by the parsing engine 130 in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket”. The hash buckets are assigned to data-storage facilities 120_{1 . . . N} and associated processing modules 110_{1 . . . N} by a hash bucket map. The characteristics of the columns chosen for the primary index determine how evenly the rows are distributed.

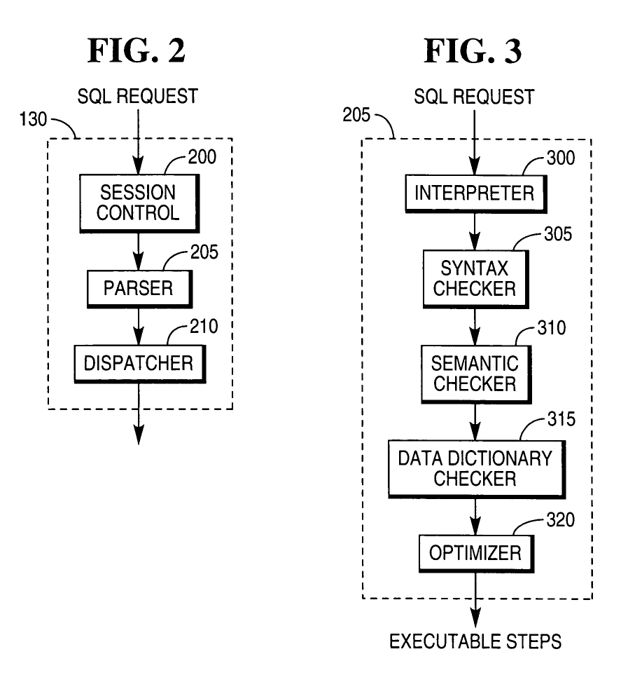

In one example system, the parsing engine 130 is made up of three components: a session control 200, a parser 205, and a dispatcher 210, as shown in FIG. 2. The session control 200 provides the logon and logoff function. It accepts a request for authorization to access the database, verifies it, and then either allows or disallows the access.

Once the session control 200 allows a session to begin, a user may submit a SQL request, which is routed to the parser 205. As illustrated in FIG. 3, the parser 205 interprets the SQL request (block 300), checks it for proper SQL syntax (block 305), evaluates it semantically (block 310), and consults a data dictionary to ensure that all of the objects specified in the SQL request actually exist and that the user has the authority to perform the request (block 315). Finally, the parser 205 runs an optimizer (block 320), which generates the least expensive plan to perform the request.

The new set of requirements arising from diverse workloads requires a different mechanism for managing the workload on a system. Specifically, it is desired to dynamically adjust resources in order to achieve a set of per-workload response time goals for complex “multi-class” workloads. In this context, a “workload” is a set of requests, which may include queries or utilities, such as loads, that have some common characteristics, such as application, source of request, type of query, priority, response time goals, etc., and a “multi-class workload” is an environment with more than one workload. Automatically managing and adjusting database management system (DBMS) resources (tasks, queues, CPU, memory, memory cache, disk, network, etc.) in order to achieve a set of per-workload response time goals for a complex multi-class workload is challenging because of the inter-dependence between workloads that results from their competition for shared resources.

The DBMS described herein accepts performance goals for each workload as inputs, and dynamically adjusts its own performance knobs, such as by allocating DBMS resources and throttling back incoming work, using the goals as a guide. In one example system, the performance knobs are called priority scheduler knobs. When the priority scheduler knobs are adjusted, weights assigned to resource partitions and allocation groups are changed. Adjusting how these weights are assigned modifies the way access to the CPU, disk and memory is allocated among requests. Given performance objectives for each workload and the fact that the workloads may interfere with each other's performance through competition for shared resources, the DBMS may find a performance knob setting that achieves one workload's goal but makes it difficult to achieve another workload's goal.

The performance goals for each workload will vary widely as well, and may or may not be related to their resource demands. For example, two workloads that execute the same application and DBMS code could have differing performance goals simply because they were submitted from different departments in an organization. Conversely, even though two workloads have similar performance objectives, they may have very different resource demands.

One solution to the problem of automatically satisfying all workload performance goals is to use more than one mechanism to manage system workload. This is because each class can have different resource consumption patterns, which means the most effective knob for controlling performance may be different for each workload. Manually managing the knobs for each workload becomes increasingly impractical as the workloads become more complex. Even if the DBMS can determine which knobs to adjust, it must still decide in which dimension and how far each one should be turned. In other words, the DBMS must translate a performance goal specification into a particular resource allocation that will achieve that goal.

The DBMS described herein achieves response times that are within a percentage of the goals for mixed workloads consisting of short transactions (tactical), long-running complex join queries, batch loads, etc. The system manages each component of its workload by goal performance objectives.

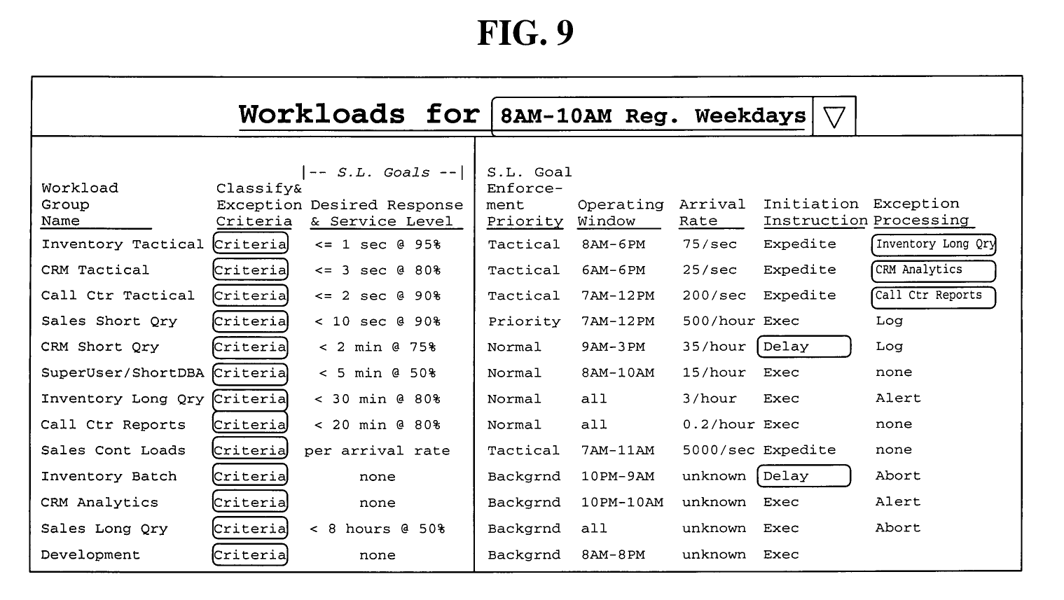

While the system attempts to achieve a “simultaneous solution” for all workloads, it attempts to find a solution for every workload independently while avoiding solutions for one workload that prohibit solutions for other workloads. Such an approach significantly simplifies the problem, finds solutions relatively quickly, and discovers a reasonable simultaneous solution in a large number of cases. In addition, the system uses a set of heuristics to control a ‘closed-loop’ feedback mechanism. In one example system, the heuristics are “tweakable” values integrated throughout each component of the architecture, including such heuristics as those described below with respect to FIGS. 9-14. Further, the system provides insight into workload response times in order to provide a much finer granularity of control over response times. Another example of the heuristics is the weights assigned to each of the resource partitions and allocation groups for a particular performance knob setting.

In most cases, a system-wide performance objective will not, in general, satisfy a set of workload-specific goals by simply managing a set of system resources on an individual query(ies) basis (i.e., sessions, requests). To automatically achieve a per-workload performance goal in a database or operating system environment, the system first establishes system-wide performance objectives and then manages (or regulates) the entire platform by managing queries (or other processes) in workloads.

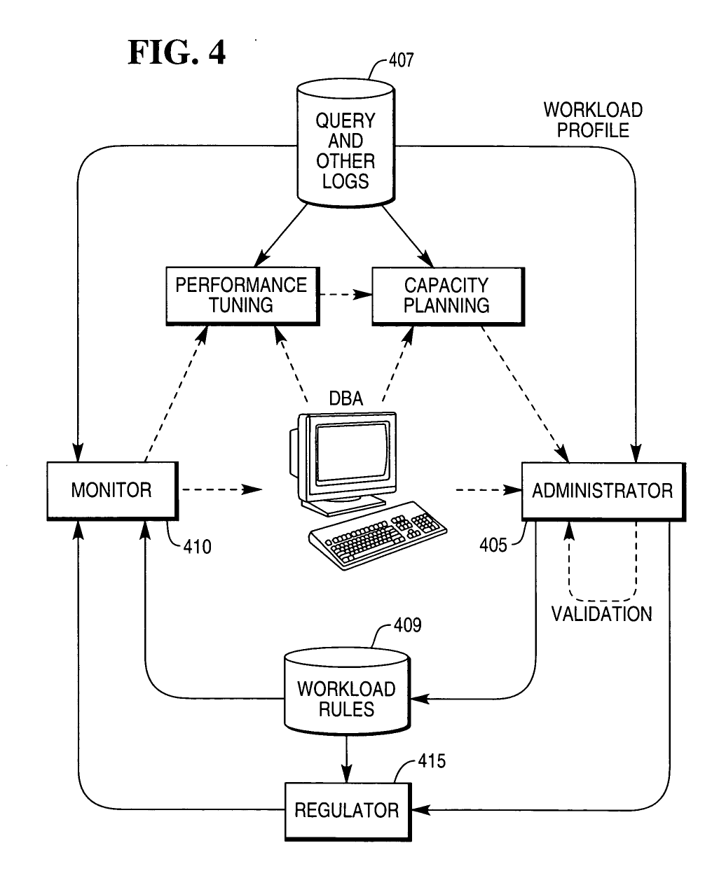

The system includes a “closed-loop” workload management architecture capable of satisfying a set of workload-specific goals. In other words, the system is an automated goal-oriented workload management system capable of supporting complex workloads and capable of self-adjusting to various types of workloads. The system's operation has four major phases: 1) assigning a set of incoming request characteristics to workload groups, assigning the workload groups to priority classes, and assigning goals (called Service Level Goals or SLGs) to the workload groups; 2) monitoring the execution of the workload groups against their goals; 3) regulating (adjusting and managing) the workload flow and priorities to achieve the SLGs; and 4) correlating the results of the workload and taking action to improve performance. The performance improvement can be accomplished in several ways: 1) through performance tuning recommendations such as the creation or change in index definitions or other supplements to table data, or to recollect statistics, or other performance tuning actions, 2) through capacity planning recommendations, for example increasing system power, 3) through utilization of results to enable optimizer self-learning, and 4) through recommending adjustments to SLGs of one workload to better complement the SLGs of another workload that it might be impacting. All recommendations can either be enacted automatically, or after “consultation” with the database administrator (“DBA”). The system includes the following components (illustrated in FIG. 4):
1) Administrator (block 405): This component provides a GUI to define workloads and their SLGs and other workload management requirements. The administrator 405 accesses data in logs 407 associated with the system, including a query log, and receives capacity planning and performance tuning inputs as discussed above. The administrator 405 is a primary interface for the DBA. The administrator also establishes workload rules 409, which are accessed and used by other elements of the system.
2) Monitor (block 410): This component provides a top level dashboard view, and the ability to drill down to various details of workload group performance, such as aggregate execution time, execution time by request, aggregate resource consumption, resource consumption by request, etc. Such data is stored in the query log and other logs 407 available to the monitor. The monitor also includes processes that initiate the performance improvement mechanisms listed above and processes that provide long term trend reporting, which may including providing performance improvement recommendations. Some of the monitor functionality may be performed by the regulator, which is described in the next paragraph.
3) Regulator (block 415): This component dynamically adjusts system settings and/or projects performance issues and either alerts the database administrator (DBA) or user to take action, for example, by communication through the monitor, which is capable of providing alerts, or through the exception log, providing a way for applications and their users to become aware of, and take action on, regulator actions. Alternatively, the regulator can automatically take action by deferring requests or executing requests with the appropriate priority to yield the best solution given requirements defined by the administrator (block 405).

### Administration of Workload Groups (Workload Management Administrator)

The workload management administrator (block 405), or “administrator,” is responsible for determining (i.e., recommending) the appropriate application settings based on SLGs. Such activities as setting weights, managing active work tasks and changes to any and all options will be automatic and taken out of the hands of the DBA. The user will be masked from all complexity involved in setting up the priority scheduler, and be freed to address the business issues around it.

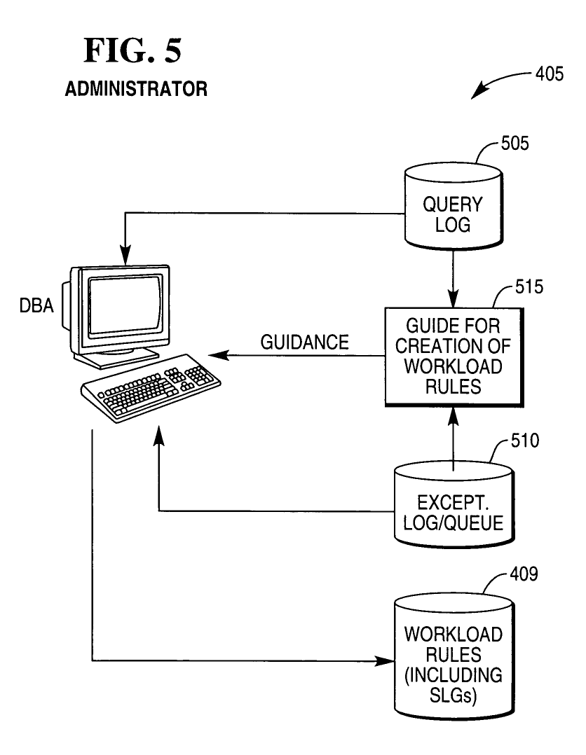

As shown in FIG. 5, the workload management administrator (block 405) allows the DBA to establish workload rules, including SLGs, which are stored in a storage facility 409, accessible to the other components of the system. The DBA has access to a query log 505, which stores the steps performed by the DBMS in executing a request along with database statistics associated with the various steps, and an exception log/queue 510, which contains records of the system's deviations from the SLGs established by the administrator. With these resources, the DBA can examine past performance and establish SLGs that are reasonable in light of the available system resources. In addition, the system provides a guide for creation of workload rules 515 which guides the DBA in establishing the workload rules 409. The guide accesses the query log 505 and the exception log/queue 510 in providing its guidance to the DBA.

The administrator assists the DBA in:
a) Establishing rules for dividing requests into candidate workload groups, and creating workload group definitions. Requests with similar characteristics (users, application, table, resource requirement, etc.) are assigned to the same workload group. The system supports the possibility of having more than one workload group with similar system response requirements.
b) Refining the workload group definitions and defining SLGs for each workload group. The system provides guidance to the DBA for response time and/or arrival rate threshold setting by summarizing response time and arrival rate history per workload group definition versus resource utilization levels, which it extracts from the query log (from data stored by the regulator, as described below), allowing the DBA to know the current response time and arrival rate patterns. The DBA can then cross-compare those patterns to satisfaction levels or business requirements, if known, to derive an appropriate response time and arrival rate threshold setting, i.e., an appropriate SLG. After the administrator specifies the SLGs, the system automatically generates the appropriate resource allocation settings, as described below. These SLG requirements are distributed to the rest of the system as workload rules.
c) Optionally, establishing priority classes and assigning workload groups to the classes. Workload groups with similar performance requirements are assigned to the same class.
d) Providing proactive feedback (ie: Validation) to the DBA regarding the workload groups and their SLG assignments prior to execution to better assure that the current assignments can be met, i.e., that the SLG assignments as defined and potentially modified by the DBA represent realistic goals. The DBA has the option to refine workload group definitions and SLG assignments as a result of that feedback.

### Internal Monitoring and Regulation of Workload Groups (Regulator)

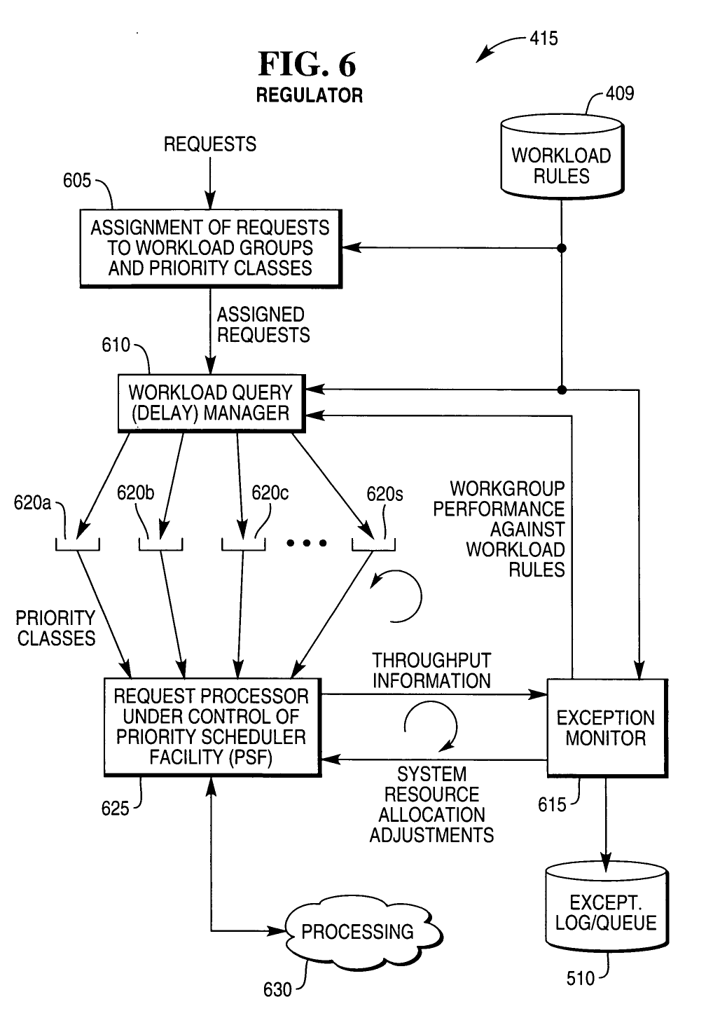

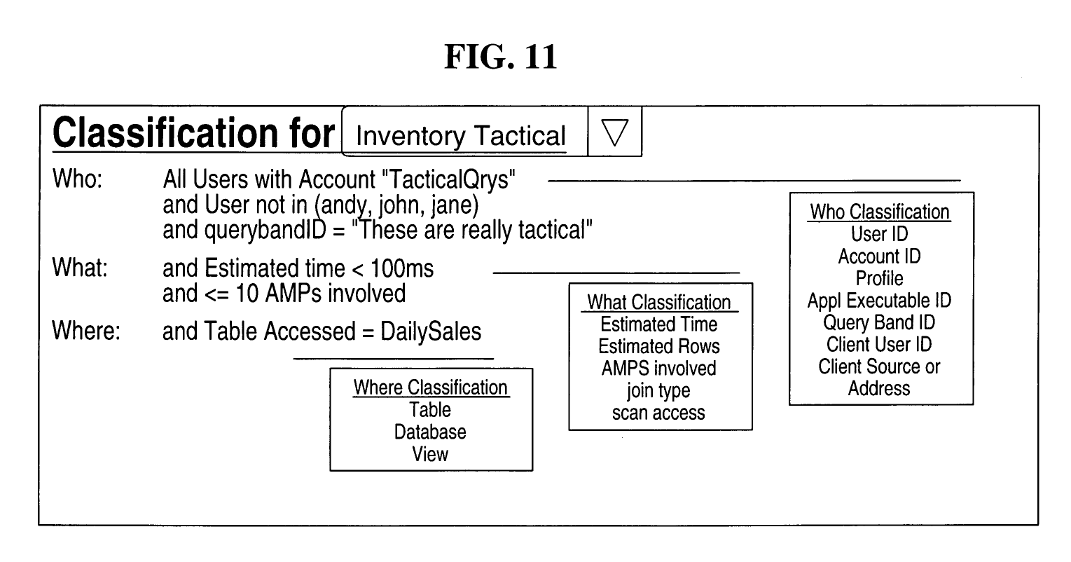

The internal monitoring and regulating component (regulator 415), illustrated in more detail in FIG. 6, accomplishes its objective by dynamically monitoring the workload characteristics (defined by the administrator) using workload rules or other heuristics based on past and current performance of the system that guide two feedback mechanisms. It does this before the request begins execution and at periodic intervals during query execution. Prior to query execution, an incoming request is examined to determine in which workload group it belongs, based on criteria described below with respect to FIG. 11. Concurrency levels, i.e., the numbers of concurrent executing queries from each workload group, are monitored, and if current workload group concurrency levels are above an administrator-defined threshold, a request in that workload group waits in a queue prior to execution until the concurrency level subsides below the defined threshold. Query execution requests currently being executed are monitored to determine if they still meet the criteria of belonging in a particular workload group by comparing request execution characteristics to a set of exception conditions. If the result suggests that a request violates the rules associated with a workload group, an action is taken to move the request to another workload group or to abort it, and/or alert on or log the situation with potential follow-up actions as a result of detecting the situation. Current response times and throughput of each workload group are also monitored dynamically to determine if they are meeting SLGs. A resource weight allocation for each performance group can be automatically adjusted to better enable meeting SLGs using another set of heuristics described with respect to FIG. 6.

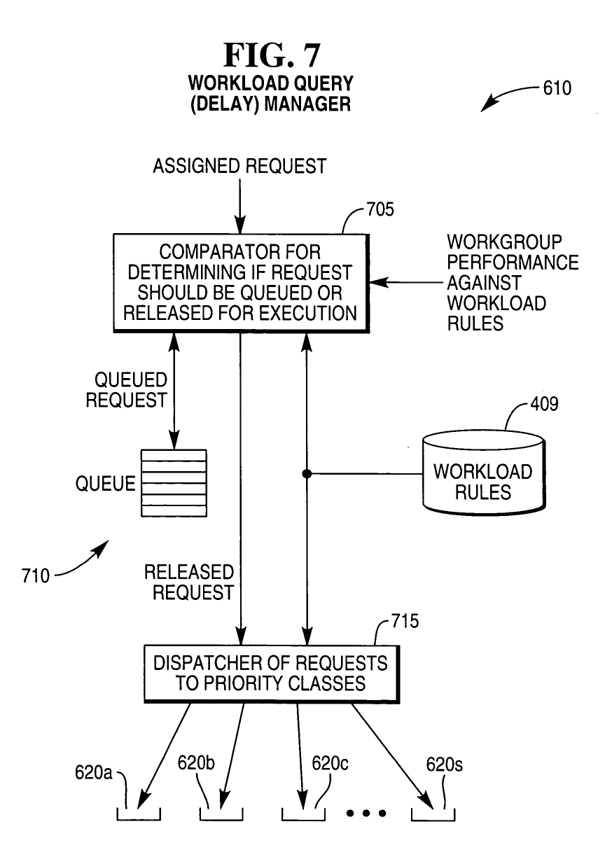

As shown in FIG. 6, the regulator 415 receives one or more requests, each of which is assigned by an assignment process (block 605) to a workload group and, optionally, a priority class, in accordance with the workload rules 409. The assigned requests are passed to a workload query (delay) manager 610, which is described in more detail with respect to FIG. 7. In general, the workload query (delay) manager monitors the workload performance compared to the workload rules and either allows the request to be executed immediately or holds it for later execution, as described below. If the request is to be executed immediately, the workload query (delay) manager 610 places the request in the priority class bucket 620a . . . s corresponding to the priority class to which the request was assigned by the administrator 405. A request processor under control of a priority scheduler facility (PSF) 625 selects queries from the priority class buckets 620a . . . s, in an order determined by the priority associated with each of the buckets, and executes it, as represented by the processing block 630 on FIG. 6.

The request processor 625 also monitors the request processing and reports throughput information, for example, for each request and for each workgroup, to an exception monitoring process 615. The exception monitoring process 615 compares the throughput with the workload rules 409 and stores any exceptions (e.g., throughput deviations from the workload rules) in the exception log/queue. In addition, the exception monitoring process 615 provides system resource allocation adjustments to the request processor 625, which adjusts system resource allocation accordingly, e.g., by adjusting the priority scheduler weights. Further, the exception monitoring process 615 provides data regarding the workgroup performance against workload rules to the workload query (delay) manager 610, which uses the data to determine whether to delay incoming requests, depending on the workload group to which the request is assigned.

As can be seen in FIG. 6, the system provides two feedback loops, indicated by the circular arrows shown in the drawing. The first feedback loop includes the request processor 625 and the exception monitoring process 615. In this first feedback loop, the system monitors on a short-term basis the execution of requests to detect deviations greater than a short-term threshold from the defined service level for the workload group to which the requests were defined. If such deviations are detected, the DBMS is adjusted, e.g., by adjusting the assignment of system resources to workload groups. The second feedback loop includes the workload query (delay) manager 610, the request processor 625 and the exception monitoring process 615. In this second feedback loop, the system monitors on a long-term basis to detect deviations from the expected level of service greater than a long-term threshold. If it does, the system adjusts the execution of requests, e.g., by delaying, swapping out or aborting requests, to better provide the expected level of service. Note that swapping out requests is one form of memory control in the sense that before a request is swapped out it consumes memory and after it is swapped out it does not. While this is the preferable form of memory control, other forms, in which the amount of memory dedicated to an executing request can be adjusted as part of the feedback loop, are also possible.

The workload query (delay) manager 610, shown in greater detail in FIG. 7, receives an assigned request as an input. A comparator 705 determines if the request should be queued or released for execution. It does this by determining the workload group assignment for the request and comparing that workload group's performance against the workload rules, provided by the exception monitoring process 615. For example, the comparator 705 may examine the concurrency level of requests being executed under the workload group to which the request is assigned. Further, the comparator may compare the workload group's performance against other workload rules.

If the comparator 705 determines that the request should not be executed, it places the request in a queue 710 along with any other requests for which execution has been delayed. The comparator 705 continues to monitor the workgroup's performance against the workload rules and when it reaches an acceptable level, it extracts the request from the queue 710 and releases the request for execution. In some cases, it is not necessary for the request to be stored in the queue to wait for workgroup performance to reach a particular level, in which case it is released immediately for execution.

Once a request is released for execution it is dispatched (block 715) to priority class buckets 620a . . . s, where it will await retrieval by the request processor 625.

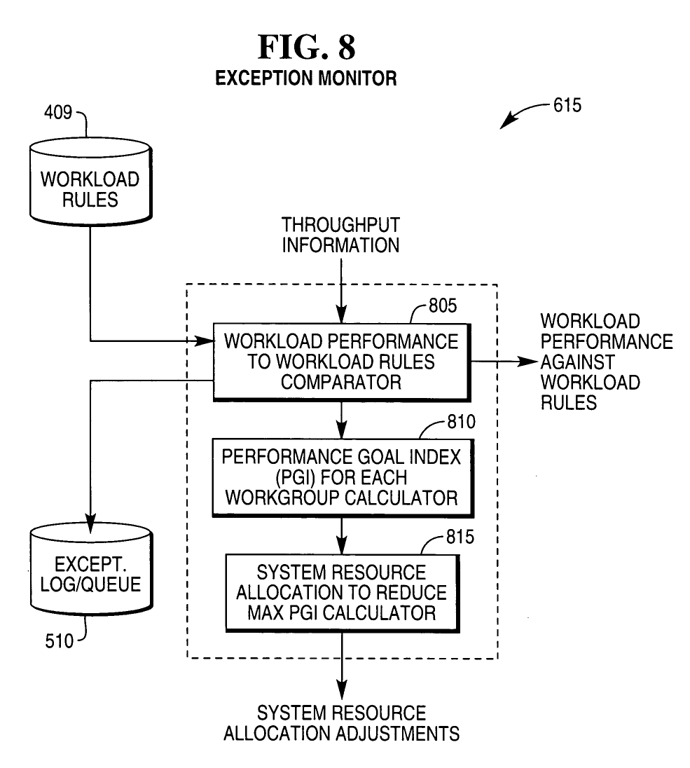

The exception monitoring process 615, illustrated in greater detail in FIG. 8, receives throughput information from the request processor 625. A workload performance to workload rules comparator 805 compares the received throughput information to the workload rules and logs any deviations that it finds in the exception log/queue 510. It also generates the workload performance against workload rules information that is provided to the workload query (delay) manager 610.

To determine what adjustments to the system resources are necessary, the exception monitoring process calculates a ‘performance goal index’ (PGI) for each workload group (block 810), where PGI is defined as the observed average response time (derived from the throughput information) divided by the response time goal (derived from the workload rules). Because it is normalized relative to the goal, the PGI is a useful indicator of performance that allows comparisons across workload groups.

The exception monitoring process adjusts the allocation of system resources among the workload groups (block 815) using one of two alternative methods. Method 1 is to minimize the maximum PGI for all workload groups for which defined goals exist. Method 2 is to minimize the maximum PGI for the highest priority workload groups first, potentially at the expense of the lower priority workload groups, before minimizing the maximum PGI for the lower priority workload groups. Method 1 or 2 are specified by the DBA in advance through the administrator.

The system resource allocation adjustment is transmitted to the request processor 625 (discussed above). By seeking to minimize the maximum PGI for all workload groups, the system treats the overall workload of the system rather than simply attempting to improve performance for a single workload. In most cases, the system will reject a solution that reduces the PGI for one workload group while rendering the PGI for another workload group unacceptable.

This approach means that the system does not have to maintain specific response times very accurately. Rather, it only needs to determine the correct relative or average response times when comparing between different workload groups.

In summary the regulator:
a) Regulates (adjusts) system resources against workload expectations (SLGs) and projects when response times will exceed those SLG performance thresholds so that action can be taken to prevent the problem.
b) Uses cost thresholds, which include CPU time, IO count, disk to CPU ratio (calculated from the previous two items), CPU or IO skew (cost as compared to highest node usage vs. average node usage), spool usage, response time and blocked time, to “adjust” or regulate against response time requirements by workload SLGs. The last two items in the list are impacted by system conditions, while the other items are all query-specific costs. The regulator will use the PSF to handle dynamic adjustments to the allocation of resources to meet SLGs.
c) Defers the query(ies) so as to avoid missing service level goals on a currently executing workload. Optionally, the user is allowed to execute the query(ies) and have all workloads miss SLGs by a proportional percentage based on shortage of resources (i.e., based on administrators input), as discussed above with respect to the two methods for adjusting the allocation of system resources.

### Monitoring System Performance (Monitor)

The monitor 410 (FIG. 4) provides a hierarchical view of workload groups as they relate to SLGs. It provides filtering options on those views such as to view only active sessions versus all sessions, to view only sessions of certain workload groups, etc.

The monitor:
a) Provides monitoring views by workload group(s). For example, the monitor displays the status of workload groups versus milestones, etc.
b) Provides feedback and diagnostics if expected performance is not delivered. When expected consistent response time is not achieved, explanatory information is provided to the administrator along with direction as to what the administrator can do to return to consistency.
d) Identifies out of variance conditions. Using historical logs as compared to current/real-time query response times, CPU usage, etc., the monitor identifies queries that are out of variance for, e.g., a given user/account/application IDs. The monitor provides an option for automatic screen refresh at DBA-defined intervals (say, every minute.)
e) Provides the ability to watch the progress of a session/query while it is executing.
f) Provides analysis to identify workloads with the heaviest usage. Identifies the heaviest hitting workload groups or users either by querying the Query Log or other logs. With the heaviest usage identified, developers and DBAs can prioritize their tuning efforts appropriately.
g) Cross-compares workload response time histories (via Query Log) with workload SLGs to determine if query gating through altered TDQM settings presents feasible opportunities for the workload.

### Graphical Interface for Creation of Workload Definitions and SLGs

The graphical user interface for the creation of Workload Definitions and their SLGs, shown in FIG. 9, includes a Workload Group Name column, which can be filled in by the DBA. Each row of the display shown in FIG. 9 corresponds to a different workload group. The example screen in FIG. 9 shows the “Inventory Tactical” workload group, the “CRM Tactical” workload group and others. For each workload group, the DBA can assign a set of service level goals. In the example shown in FIG. 9, the service level goals include the “desired response & service level” and “enforcement policy.” The desired response & service level for the Inventory Tactical workload group is “<=1 sec@95%”, which means that the DBA has specified that the Inventory Tactical workload group goal is to execute within 1 second 95 percent of the time. The enforcement priority for the Inventory Tactical workload group is “Tactical”, which gives this workload group the highest priority in achieving its desired response & service level goals. A lower priority, “Priority”, is assigned to the Sales Short Qry workload group. As can be seen in FIG. 9, multiple workload groups can be assigned the same enforcement priority assignments. That is, the Sales Cont Loads, Inventory Tactical, CRM Tactical and Call Ctr Tactical workload groups all have “Tactical” as their enforcement priority.

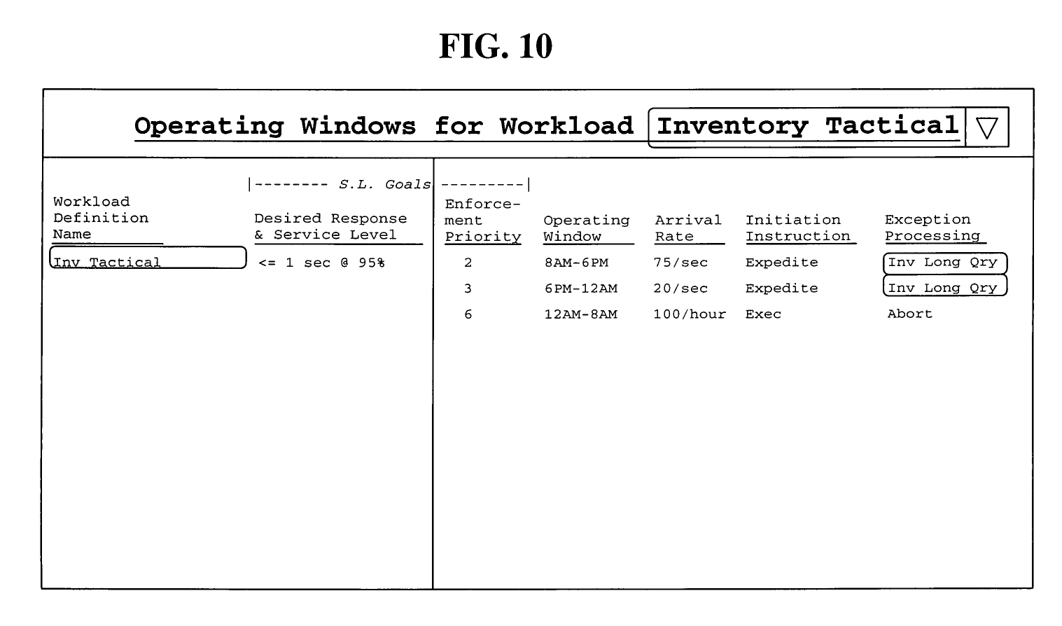

Each workload group also has an “operating window,” which refers to the period of time during which the service level goals displayed for that workload group are enforced. For example, the Inventory Tactical operating group has the service level goals displayed on FIG. 9 from 8 AM-6 PM. The service level goals can be changed from one operating window to another, as indicated below in the discussion of FIG. 10.

Each workload group is also assigned an arrival rate, which indicates the anticipated arrival rate of this workload. This is used for computing initial assignment of resource allocation weights, which can be altered dynamically as arrival rate patterns vary over time.

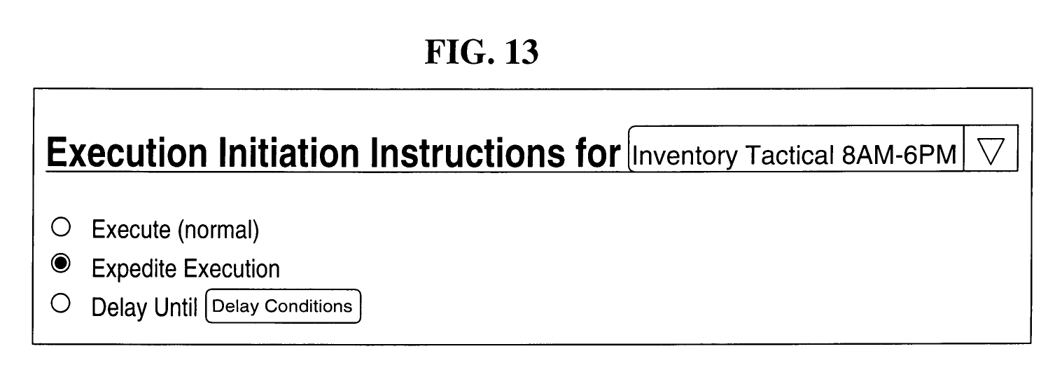

Each workload group is also assigned an “initiation instruction,” which indicates how processes from this workload group are to be executed. An initiation instruction can be (a) “Expedite,” which means that requests from this workload group can utilize reserved resources, known as Reserved Amp Worker Tasks, rather than waiting in queue for regular Amp Worker Tasks to become available, (b) “Exec,” which means the request is executed normally, ie: without expedite privileges, or (c) “Delay,” which means the request must abide by concurrency threshold controls, limiting the number of concurrent executing queries from this workload group to some specified amount. Initiation instructions are discussed in more detail with respect to FIG. 13.

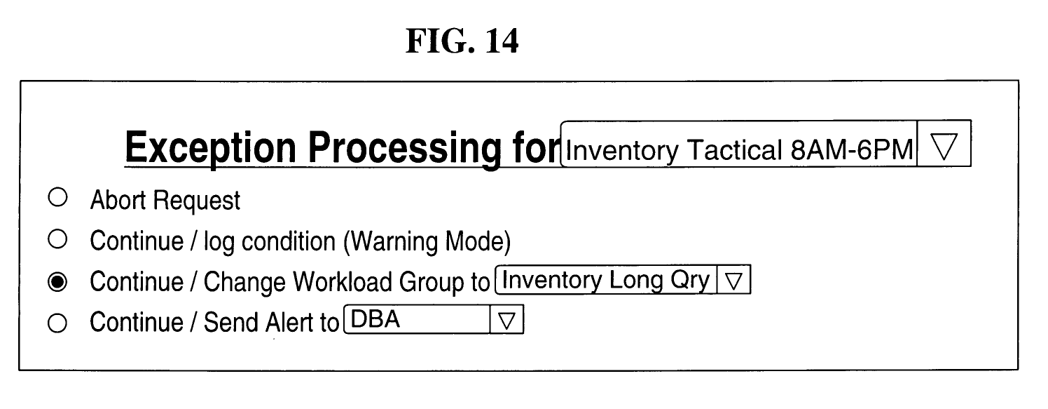

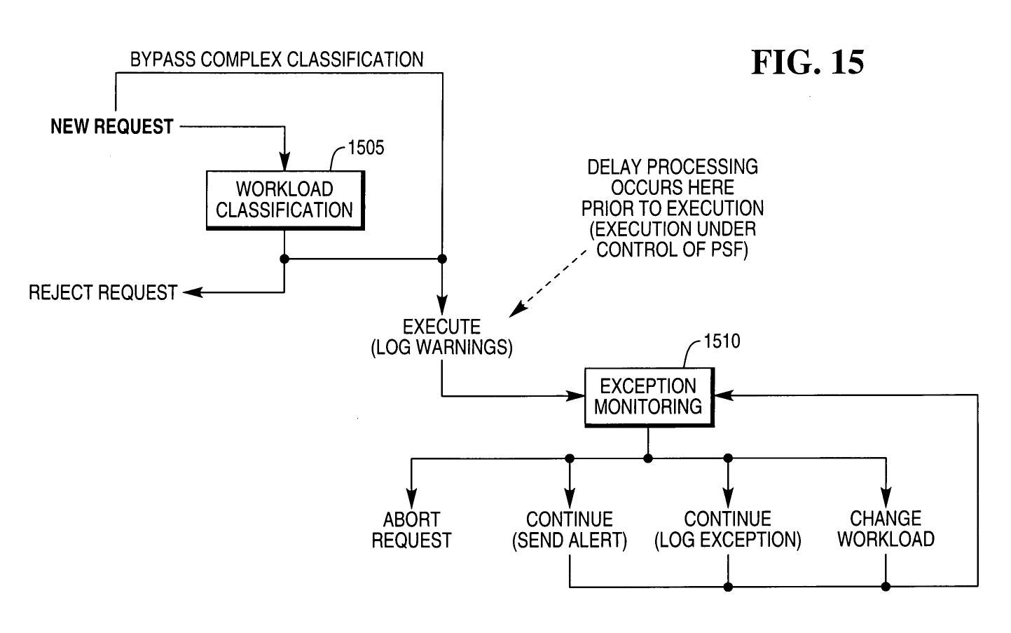

Each workload group is also assigned an “exception processing” parameter, which defines the process that is to be executed if an exception occurs with respect to that workload group. For example, the exception processing for the Inventory Tactical workload group is to change the workload group of the executing query to Inventory LongQry, adopting all the characteristics of that workload group. Exception processing is discussed in more detail with respect to FIGS. 14-15.

Some of these parameters (ie: enforcement priority, arrival rate, initiation instructions, and exception processing) can be given different values over different operating windows of time during the day, as shown in FIG. 10. In the example shown in FIG. 10, three operating windows are defined: (a) 8 AM-6 PM (which corresponds to the operating window depicted in FIG. 9); (b) 6 PM-12 AM; and (c) 12 AM-8 AM. The “enforcement priority” parameter, for example, has three different values over the three operating windows in FIG. 10, meaning that the enforcement priority of this workload group will vary throughout the day. Some embodiments, however, limit one or more of these parameters to constant values across all operating windows. Requiring a constant “enforcement priority” parameter, for example, simplifies the task of enforcing workload priorities.

Each of the highlighted zones in shown in FIG. 9 or 10 (i.e., the workload definition name, the initiation instructions and the exception processing definition) indicate buttons on the screen that can be activated to allow further definition of that parameter. For example, pressing the “Inv Tactical” button on FIG. 10 causes the screen shown in FIG. 11, which is the classification criteria for the Inventory Tactical workgroup, to be displayed. Through this screen, the DBA can define the request sources (who), the tables/views/databases that can be accessed (where) and/or the request resource usage predictions that can execute processes in the Inventory Tactical workgroup. The keywords shown in the highlighted boxes of FIG. 11 (who classification: User ID, Account ID, Profile, Appl Executable ID, Query Band ID, Client User ID, Client Source or Address; what classification: Estimated Time, Estimated Rows, AMPs involved, Join Type, Scan Type; where classification: Table Accessed, Database Accessed, View Accessed; other where classification criteria include stored procedure, macro, and UDF) can be used to formulate the query classification. In the example shown in FIG. 11, the “who” portion of the classification definition is:
All Users with Account “TacticalQrys”
and User not in (and,john,jane)
and querybandID=“These are really tactical”

In the example shown in FIG. 11, the “what” portion of the classification has been defined as:
Estimated time<100 ms AND
<=10 AMPs involved
   Note that the “estimated time” line of the “what” portion of the classification could be rephrased in seconds as “Estimated time<0.1 seconds AND”.

In the example shown in FIG. 11, the “where” portion of the classification has been defined as:
Table Accessed=DailySales

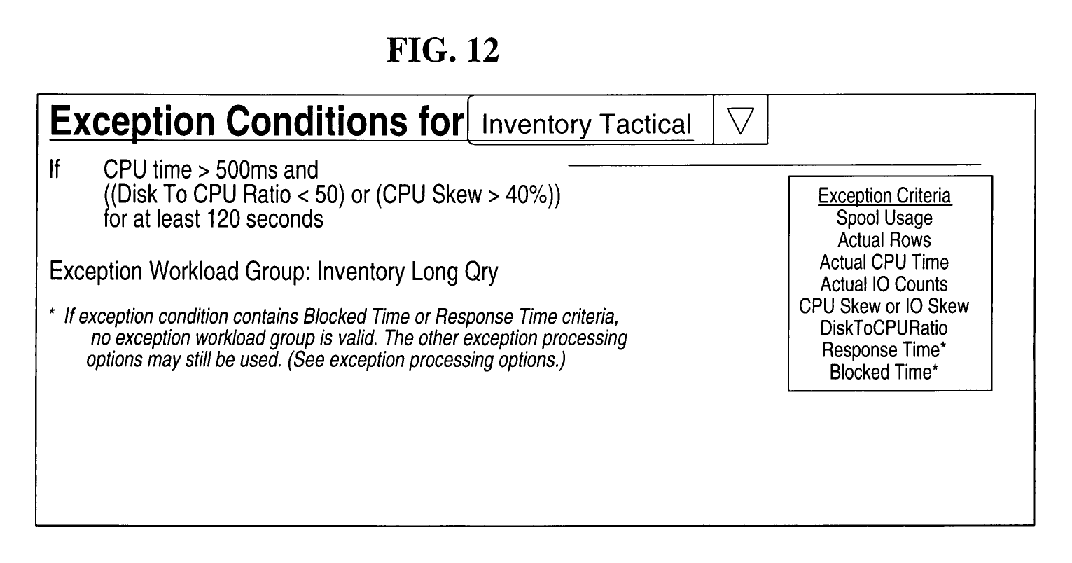

If one of the buttons shown under the exception processing column in FIGS. 9 and 10 is pressed, the screen shown in FIG. 12 appears, allowing specification of the exception conditions and processing for the selected workload group. The keywords shown in the highlighted box in the Exception Thresholds zone of the screen shown in FIG. 11 (Spool Usage, Actual Rows, Actual CPU Time, Actual IO Counts, CPU or IO Skew, Disk to CPU Ratio, Response Time and Blocked Time) can be used to formulate the Exceptions Thresholds criteria. If an exception occurs, and if the DBA desires the system to potentially continue the request under a different workload group, that workload group is defined here. In a sense, an exception indicates that the request is displaying query characteristics that are not in keeping with the norm for this workload group, so it must instead belong in the alternative workload group designated on the screen shown in FIG. 12. There are two exception conditions where this assessment could be in error: Response Time and Blocked Time. Both Response Time and Blocked Time can cause request performance to vary because of system conditions rather than the characteristics of the query itself. If these exception criteria are defined, in one example the system does not allow an alternative workload group to be defined. In one example system, some conditions need to be present for some duration before the system takes action on them. For example, a momentary skew or high disk to CPU ratio is not necessarily a problem, but if it continues for some longer period of time, it would qualify as a problem that requires exception processing. In the example shown in FIG. 12, the Exceptions Thresholds have been defined as:
CPU Time (i.e., CPU usage)>500 ms and
(Disk to CPU Ratio>50) or (CPU Skew>40%)) for at least 120 seconds

Clicking on one of the buttons under the “initiation instruction” column in the display shown in FIGS. 9 and 10 causes the execution initiation instructions screen, shown in FIG. 13, to be displayed. For example, through the display shown in FIG. 13, the Execution Initiation Instructions for the Inventory Tactical workgroup for the operating window from 8 AM-6 PM can be displayed and modified. In the example shown in FIG. 13, the three options for Execution Initiation Instruction are “Execute (normal),” “Expedite Execution,” and “Delay Until”, with the last selection having another button, which, when pressed, allows the DBA to specify the delay conditions. In the example shown in FIG. 13, the Expedite Execution execution instruction has been selected, as indicated by the filled-in bullet next to that selection.

Returning to FIG. 10, the details of the Exception Processing parameter can be specified by selecting one of the highlighted buttons under the Exception Processing heading. For example, if the button for the 8 AM-6 PM operating window is pressed, the screen shown in FIG. 14 is displayed. The screen shown in FIG. 14 provides the following exception processing selections: (a) “Abort Request”; (b) “Continue/log condition (Warning Mode)”; and (c) “Continue/Change Workload Group to” the workload group allowed when the exception criteria were described in the screen shown in FIG. 12; and (d) “Continue/Send Alert to [pulldown menu for possible recipients for alerts]. ” If selection (a) is chosen, the associated request is aborted if an exception occurs. If selection (b) is chosen, an exception is logged in the exception log/queue 510 if one occurs. If selection (c) is chosen, and it is in the example shown in FIG. 14, as indicated by the darkened bullet, the request is automatically continued, but in the different work group pre-designated in FIG. 12. If selection (d) is chosen, processing of the request continues and an alert is sent to a destination chosen using the pulldown menu shown. In the example shown in FIG. 14, the chosen destination is the DBA.

The flow of request processing is illustrated in FIG. 15. A new request is classified by the workload classification block 1505 in which it is either rejected, and not executed, or accepted, and executed. As shown in FIG. 15, the execution delay set up using the screen illustrated in FIG. 13 occurs prior to execution under the control of PSF. The execution is monitored (block 1510) and based on the exception processing selected through the screen illustrated in FIG. 14, the request is aborted, continued with an alert being sent, continued with the exception being logged, or continued with the request being changed to a different workload, with perhaps different service level goals.

### “Dashboard” Monitor

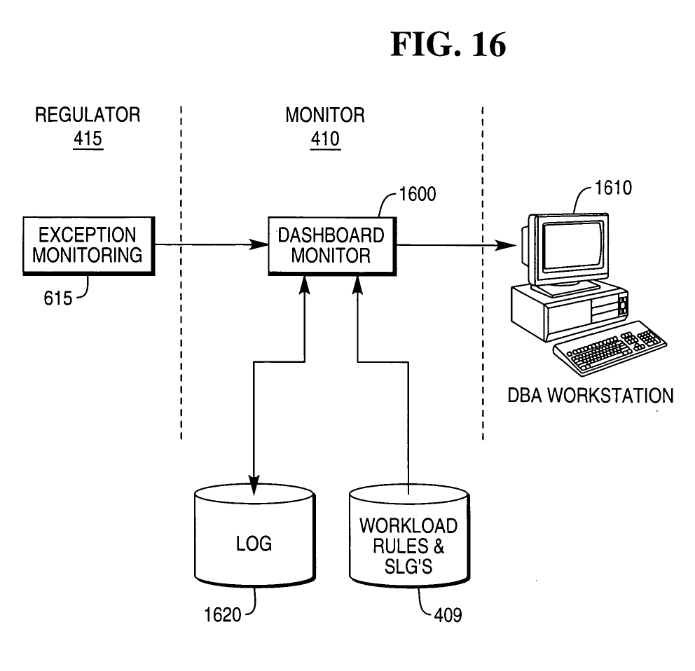

FIG. 16 is a block diagram showing how the Monitor 410 (FIG. 4) and the Regulator 415 (FIG. 4) work together to allow real-time monitoring of the performance of workload groups within the database system. The Monitor 410 includes a dashboard workload monitor program, or simply dashboard monitor 1600, that allows the database administrator (DBA) to receive performance information on the workload groups within the database system. The dashboard monitor 1600 interfaces with the exception monitoring process 615 (FIG. 8) of the Regulator 415, receiving from that process information about the performance of each workload group. This information is typically refreshed by the Regulator 415 in real-time, e.g., once every minute or less. The dashboard monitor 1600 places this information in a log 1620 containing one or more tables, where it typically remains for only a short time, e.g., no more than hour.

As described with reference to FIG. 8 above, the exception monitoring process 615 in the Regulator 415 receives a wide variety of information—including, for example, information about the processor, disk, and communication demands for transactions within each workload group; the number of transactions within each workload group that are running on each node in the database system; and the average response times for transactions within each workload group on each node—and generates information indicating how the various workload groups are performing against the workload rules established by the DBA. The dashboard monitor receives this information from the Regulator 415 and uses it to generate reports, which are delivered to a workstation 1610 used by the DBA.

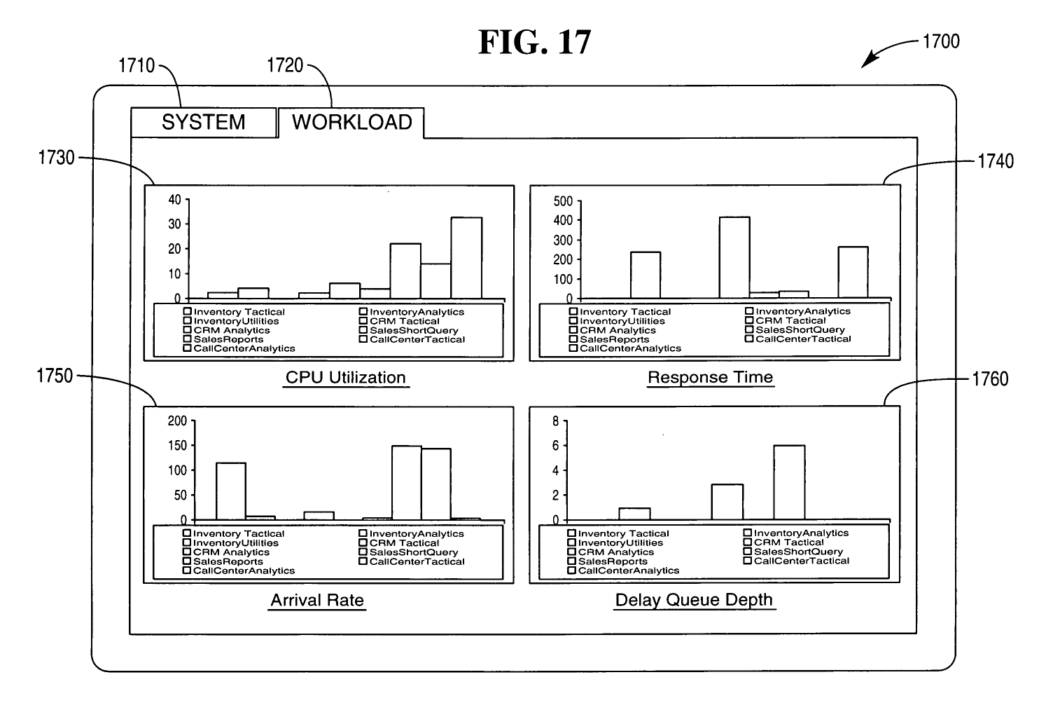

FIG. 17 shows a graphical interface 1700 that is provided to the DBA by the dashboard monitor 1600. The interface 1700 modifies a traditional system-monitoring interface by providing some mechanism, such a clickable “tabs,” that allow the DBA to toggle between traditional system-monitoring information (using a “System” tab 1710) and the workload-performance information (using a “Workload” tab 1720) provided by the dashboard monitor 1600. In the example shown here, selecting the “Workload” tab 1720 creates a display of four charts for the DBA—a “CPU Utilization” chart 1730, a “Response Time” chart 1740, an “Arrival Rate” chart 1750, and a “Delay Queue Depth” chart 1760. The “CPU Utilization” chart 1730 shows, for each workload group, the percentage of CPU cycles consumed by transactions within that workload group. The “Response Time” chart 1740 shows, for each workload group, the average response time by the database system to requests within that workload group. The “Arrival Rate” chart 1750 shows, for each workload group, the average rate at which requests within that group are arriving at the database system. The “Delay Queue Depth” chart 1760 shows, for each workload group, the number of requests within that group that are sitting in the delay queue.

The dashboard monitor 1600 also draws upon the workload rules 409 (FIG. 4) and the information (e.g., CPU usage, query response times) contained in the log 1620 to identify out-of-variance conditions and for the DBA. When desired, the DBA can ask the dashboard monitor 1600 to identify out-of-variance conditions by transaction source, such as by user, by account, or by application ID. This information is accessible to the DBA through the graphical interface 1700 described above.

In some embodiments, the graphical interface 1700 to the dashboard monitor 1600 also presents the DBA with a wide variety of other information derived from the workload-performance information that is collected from the Regulator 415. Among the information available to the DBA are the following:
Minimum/maximum/average CPU usage per workload group
Number of active sessions per workload group
List of active session numbers for each workload group
Arrival rate of active requests per workload group
Number of requests completed successfully per workload group
Minimum/maximum/average response times of completed requests per workload group
Number of requests that fell outside the established SLG for each workload group
Number of requests currently in delay queue for each workload group
List of session numbers, workload group names, and delay rules of sessions with requests in delay queue
Number of requests causing an exception per workload group
Number of users logged on vs. database limits
Number of queries running vs. database limits

### The Workload Correlator—Trend Analysis

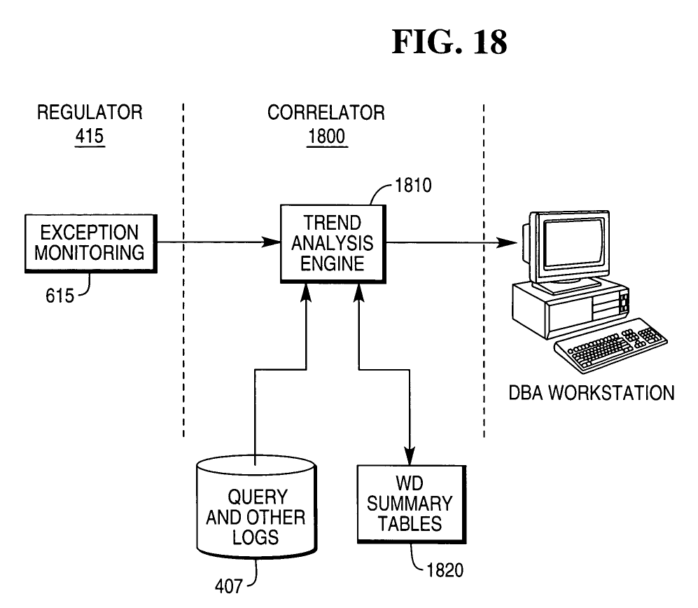

FIG. 18 is a block diagram showing a Workload Correlator 1800 that allows the DBA to understand trends over long periods of time (e.g., day, week, month, year) in the usage of database resources by the various workload groups. The Workload Correlator 1800 includes a trend analysis engine 1810 that, like the dashboard monitor described above, interfaces with the exception monitoring process 615 of the Regulator 415. The trend analysis engine 1810 receives information about the performance of the various workload groups from the Regulator 415 and from the query log and other logs 407 and uses this information to populate one or more workload-definition (WD) summary tables 1820. In various embodiments, the WD summary tables 1820 are used to store a wide variety of database-performance metrics, including (but certainly not limited to) arrival rates, response times, and CPU-usage times for requests in each workload group, and the counts and percentages of requests exceeding the established SLG for each workload group.

The trend analysis engine 1810 includes a GUI filtering component, or “filter” 1900, that allows a human user, such as a database administrator (DBA), to indicate how the information received from the Regulator 415 and the logs 407 is to be summarized before it is placed in the WD summary tables 1820. In the example shown here, the filter 1900 includes a series of data-entry boxes, buttons and menus (collectively a “time period” box 1910) that allow the user to select a time period over which data is to be summarized. The time period box 1910, for example, allows the user to select a start date and an end date for the information to be summarized in the WD summary tables 1820, as well as the days of the week and the time windows during those days for which summary information is to be included. The time period box 1910 shown here also allows the user to select a “GROUP BY” parameter for the summary data—e.g., grouping by day, by week, by month, etc.

The filter 1900 as shown here also includes a menu 1920 that allows the user to select the type of information to be included in the WD summary tables 1820. In this example, the choices include data relating to all workload definitions, users, accounts, profiles, client IDs, query bands, or error codes, or data relating to some specific workload definition, user, account, profile, client ID, query band or error code. The filter 1900 also allows the user to set controls indicating how the summary information is be displayed (e.g., “table” vs. “graph”), which categories of information are to be included (e.g., “Condition Indicator Count,” “Response Time,” “Resource Usage,” and “Parallelism”), and whether other types of resource-usage information (e.g., number of processing modules, or AMPs, used by a workload; database row count; and spool usage) is to be included.

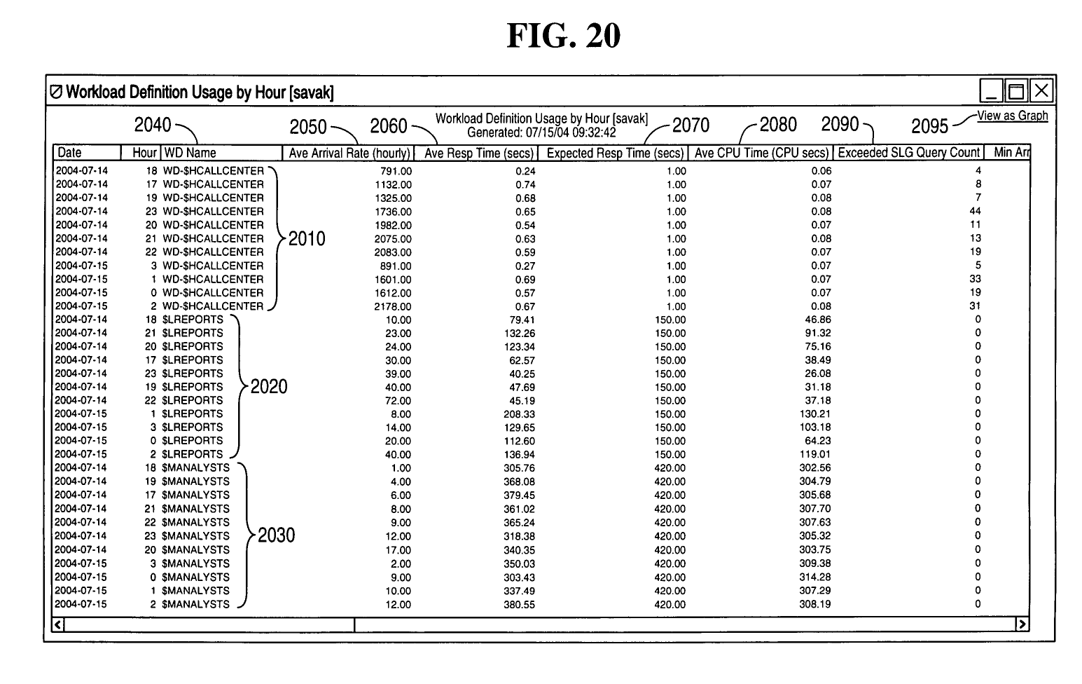

The trend analysis engine 1810 draws from the data stored in the WD summary tables 1820 in producing reports that it delivers to a workstation for viewing by the DBA. These reports are displayed in a graphical user interface, several components of which are shown in FIGS. 20 through 23. FIG. 20 shows, in tabular format, database-performance metrics for several example workload groups—a call center group 2010 (“HCALLCENTER”), a reports group 2020 (“LREPORTS”), and an analysts group 2030 (“MANALYSTS”)—over a two-day period. The information in FIG. 20 is displayed in many columns, including a “WD Name” column 2040 that identifies the workload groups by name; an “Ave Arrival Rate” column 2050 that indicates the average rate of arrival for requests in each workload group during several one-hour periods; an “Ave Response Time” column 2060 that indicates the average response time by the database system in executing requests during those one-hour periods; an “Expected Resp Time” column 2070 that indicates the expected response time in completing requests for each workload group (one second for requests from the call center group, 150 seconds for requests from the reports group, and 420 seconds for requests from the analysts group, in this example); and “Ave CPU Time” column 2080 that indicates the average CPU usage per workload group during the one-hour periods; and an “Exceeded SLG Query Count” column 2090 that indicates the number of requests that exceeded the established service-level goal (SLG) for each workload group during those one-hour periods. In other embodiments, many other pieces of information are displayed in this report in addition to or in lieu of the information described here.

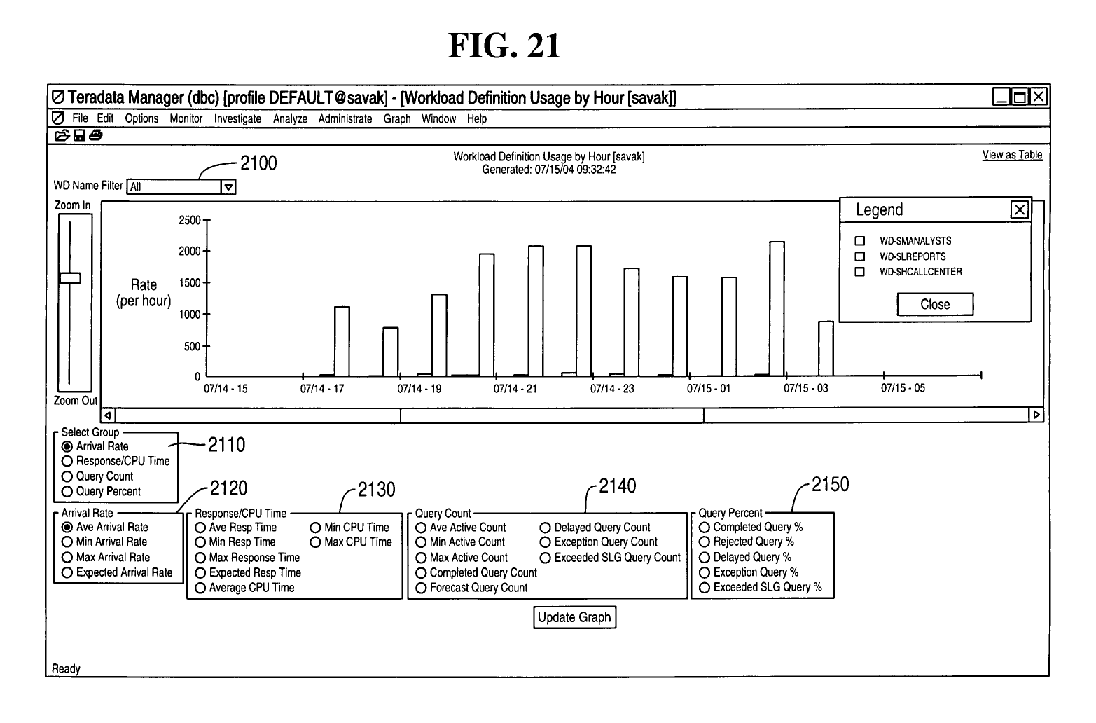

The report of FIG. 20 also includes a hyperlink 2095 that allows the user to switch the report format from the tabular format of FIG. 20 to the graphical format shown in FIG. 21. The graph of FIG. 21 provides a histogram of a certain database resource usage characteristic of each of the three workload groups (the call center group 2010, the reports group 2020, and the analysts group 2030) over a 15-hour period, beginning in the 15^{th} hour of Jul. 14, 2004, and ending in the 5^{th} hour of Jul. 15, 2004. When shown in graphical form, the report includes several selection boxes that allow the DBA to select which bits of usage information will be displayed. In this example, a “Select Group” box 2110 allows the DBA to choose from among the arrival rate data, the average response/CPU time data, data about the number of queries (or requests) that share some common characteristic (such as exceeded the established SLG value), and data about the percentage of queries that share some common characteristic. For each of these choices, the report includes another box—an “Arrival Rate” box 2120, a “Response/CPU Time” box 2130, a “Query Count” box 2140, and a “Query Percent” box 2150—that allow the DBA to make additional display choices. In this example, the DBA has chosen the “Arrival Rate” option in the “Select Group” box 2110 and the “Ave Arrival Rate” (average arrival rate) option in the “Arrival Rate” box 2120. The report therefore displays, in graphical form, the average arrival rates, per hour, for requests in each of the three workload groups over the 15-hour period of interest.

A filter menu 2100 in the graph of FIG. 21 allows the DBA to select which of the three workload groups for which information is to be displayed. As shown here, the DBA has chosen to display information for all three workload groups at once. By choosing the name of one of the workload groups from the filter menu 2100, however, the DBA can change the display to include data for only that one group.

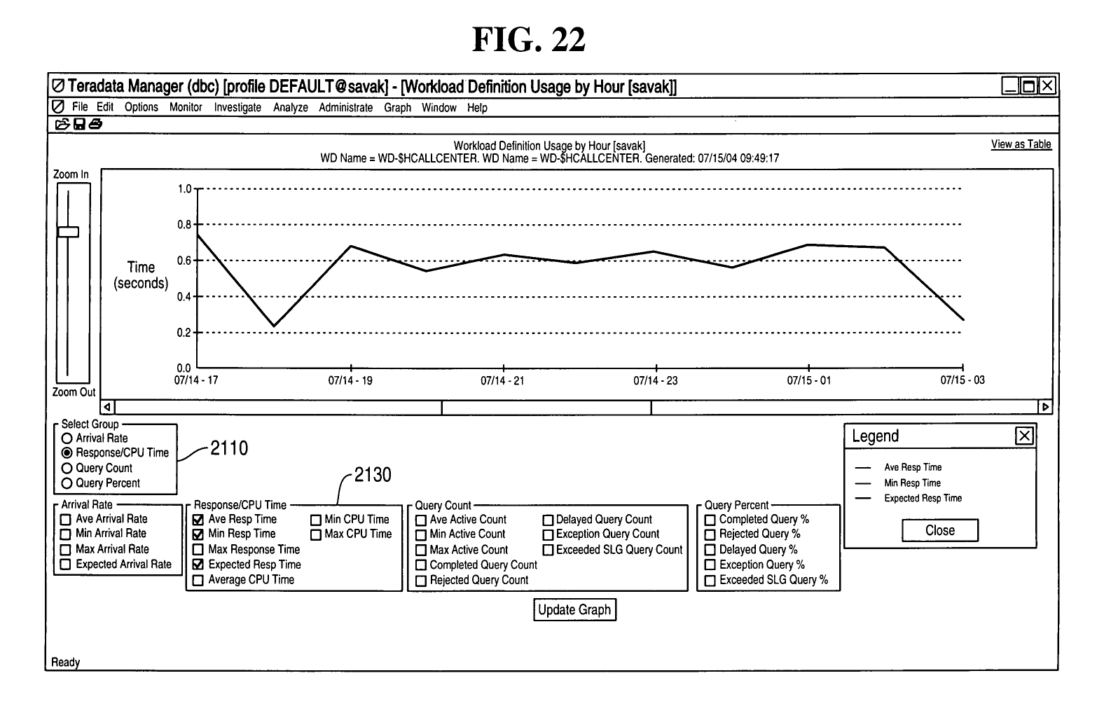

FIG. 22 shows how the graphical display changes when the DBA chooses alternative options in the various options boxes. In this example, the DBA has selected the name of the call center group (“HCALLCENTER”) in the filter menu 2100 of FIG. 21, limiting the data displayed to only that relating to requests in the call center group. The DBA has also selected the “Response/CPU Time” option in the “Select Group” box 2110 and the “Ave Resp Time,” “MMin. Resp. Time,” and “Expected Resp. Time” options in the “Response/CPU Time” box 2130. The report of FIG. 22, therefore, shows in graphical form the average, minimum, and expected response times for requests in the call center group during the 15-hour period in question.

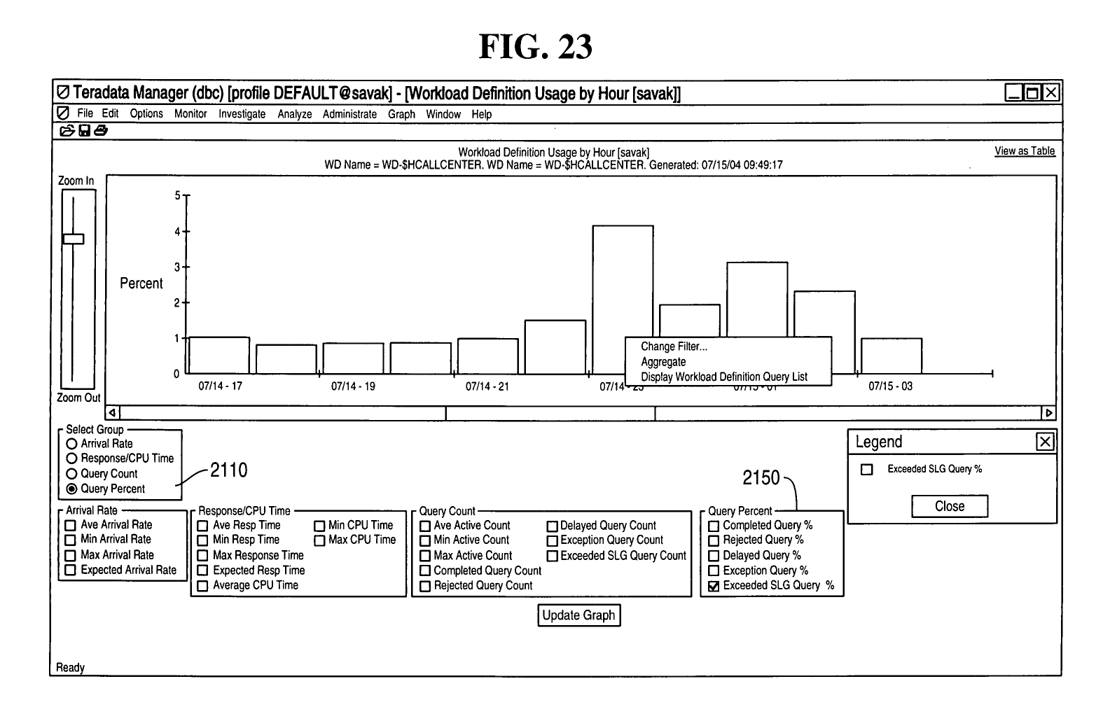

FIG. 23 shows how the graphical display changes when the DBA chooses the “Query Percent” option in the “Select Group” box 2110 and the “Exceeded SLG Query %” option in the “Query Percent” box 2150. FIG. 23, therefore, shows the percentage of requests in the call center group that exceeded the established SLG for that workload group during each of the one-hour periods in question.

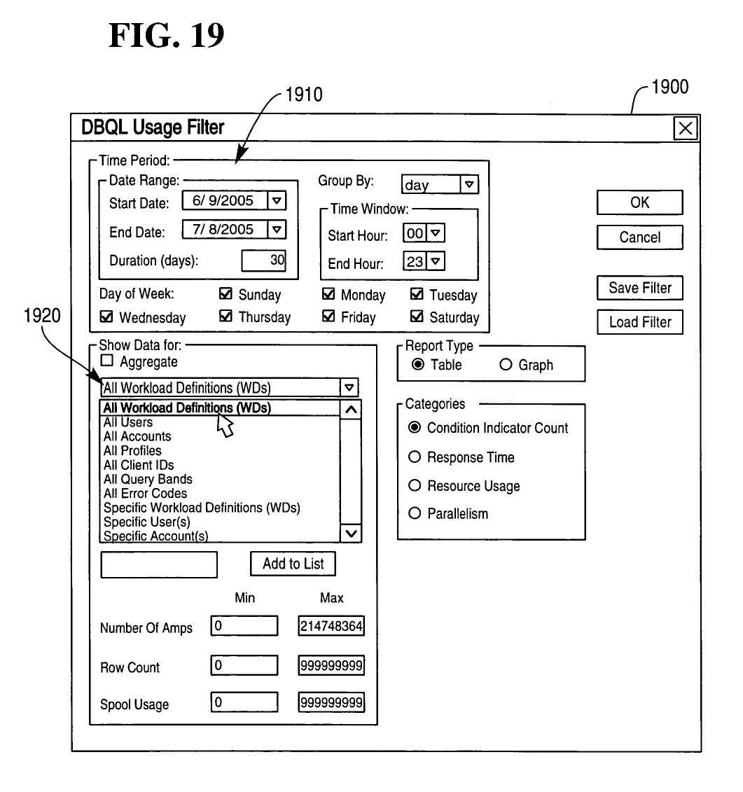

It should be understood that the tabular and graphical displays shown in FIGS. 19 through 23 are examples given for illustrative purposes only. Virtually any combination of information about database resource usage by workload groups could be combined to provide virtually any type of visual display to the database administrator. What is important is not the precise type of information that is displayed or the precise form in which it is displayed, but rather that usage information per workload group is displayed to the DBA in a manner that allows the DBA to understand trends in resource usage and the relative performance of the database system among the various workload groups.

The text above described one or more specific embodiments of a broader invention. The invention also is carried out in a variety of alternative embodiments and thus is not limited to those described here. For example, while the invention has been described here in terms of a DBMS that uses a massively parallel processing (MPP) architecture, other types of database systems, including those that use a symmetric multiprocessing (SMP) architecture, are also useful in carrying out the invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for use in analyzing performance of a database system as it executes requests that are sorted into multiple workload groups, where each workload group has an associated level of service that is desired from the database system, the method comprising:
gathering data that describes one or more performance metrics for the database system as it executes the requests in at least one of the workload groups;
organizing the data in a format that shows changes in the performance metrics over time; and
delivering the data in this format for viewing by a human user.

2. The method of claim 1, where gathering data includes gathering data that indicates an average arrival rate for requests in at least one of the workload groups during each of multiple measured time periods.

3. The method of claim 1, where gathering data includes gathering data that indicates an average response time by the database system in completing requests from at least one of the workload groups during each of multiple measured time periods.

4. The method of claim 1, where gathering data includes gathering data that indicates an average amount of CPU time consumed in completing requests from at least one of the workload groups during each of multiple measured time periods.

5. The method of claim 1, where gathering data includes gathering data that indicates a number of requests in at least one of the workload groups for which an actual level of service exceeds the desired level of service during each of multiple measured time periods.

6. The method of claim 1, where gathering data includes gathering data that identifies at least one of the workload groups by name.

7. The method of claim 1, where organizing the data includes placing the data in tabular format, with each tabular row storing one or more performance metrics gathered during one of multiple measured time periods.

8. The method of claim 1, where organizing the data includes placing the data in graphical format, with one graphical axis representing the passage of multiple measured time periods.

9. The method of claim 1, further comprising receiving an instruction from the user to change the format in which the data is organized for display.

10. The method of claim 1, further comprising receiving an instruction from the user to change the data delivered for display from one set of performance metrics to another.

11. A computer program, stored on a tangible storage medium, for use in analyzing performance of a database system as it executes requests that are sorted into multiple workload groups, where each workload group has an associated level of service that is desired from the database system, the program comprising executable instructions that cause a computer to:
gather data that describes one or more performance metrics for the database system as it executes the requests in at least one of the workload groups;
organize the data in a format that shows changes in the performance metrics over time; and
deliver the data in this format for viewing by a human user.

12. The program of claim 11, where, in gathering data, the computer gathers data that indicates an average arrival rate for requests in at least one of the workload groups during each of multiple measured time periods.

13. The program of claim 11, where, in gathering data, the computer gathers data that indicates an average response time by the database system in completing requests from at least one of the workload groups during each of multiple measured time periods.

14. The program of claim 11, where, in gathering data, the computer gathers data that indicates an average amount of CPU time consumed in completing requests from at least one of the workload groups during each of multiple measured time periods.

15. The program of claim 11, where, in gathering data, the computer gathers data that indicates a number of requests in at least one of the workload groups for which an actual level of service exceeds the desired level of service during each of multiple measured time periods.

16. The program of claim 11, where, in gathering data, the computer gathers data that identifies at least one of the workload groups by name.

17. The program of claim 11, where, in organizing the data, the computer places the data in tabular format, with each tabular row storing one or more performance metrics gathered during one of multiple measured time periods.

18. The program of claim 11, where, in organizing the data, the computer places the data in graphical format, with one graphical axis representing the passage of multiple measured time periods.

19. The program of claim 11, where the program enables the computer to receive an instruction from the user to change the format in which the data is organized for display.

20. The program of claim 11, where the program enables the computer to receive an instruction from the user to change the data delivered for display from one set of performance metrics to another.
